(19) United States
(12) Patent Application Publication
(10) Pub. No.: US 2026/0072302 A1
(43) Pub. Date: Mar. 12, 2026

(54) DISPLAY APPARATUS

(71) Applicant: Japan Display Inc., Tokyo (JP)

(72) Inventor: Takayuki IMAI, Tokyo (JP)

(21) Appl. No.: 19/316,021

(22) Filed: Sep. 2, 2025

(30) Foreign Application Priority Data
Sep. 10, 2024 (JP) 2024-156810

(51) Int. Cl. G02F 1/1333; G02F 1/13357; G09G 3/34

(52) U.S. Cl. CPC G02F 1/133382; G02F 1/133615; G09G 3/3413

(57) ABSTRACT

A performance of a display apparatus is improved. The display apparatus includes: a first substrate; a second substrate facing the first substrate; a liquid crystal layer provided between the first substrate and the second substrate; a heater having a terminal and overlapping a region where the liquid crystal layer is provided in plan view; a measurement circuit having a terminal electrically connectable to the terminal of the heater; a heater driving circuit having a terminal electrically connectable to the terminal of the heater; and a switch circuit, in which the switch circuit is capable of switching on and off of an electrical connection state between the terminal of the heater and the terminal of the measurement circuit and is capable of switching on and off of an electrical connection state between the terminal of the heater and the terminal of the heater driving circuit.

### CROSS-REFERENCE TO RELATED APPLICATION

The present application claims priority to Japanese Patent Application No. 2024-156810 filed on Sep. 10, 2024, the disclosure of which is incorporated herein by reference.

### TECHNICAL FIELD OF THE INVENTION

The present invention relates to a display apparatus.

### BACKGROUND OF THE INVENTION

A Patent Document 1 (Japanese Patent Application Laid-Open Publication No. 2006-47455) describes a liquid crystal display apparatus for vehicle, including a liquid crystal panel and a transparent planar heater including a transparent conductive film for heating formed on one surface of a transparent planar base member. A Patent Document 2 (Japanese Patent Application Laid-Open Publication No. 2019-78979) describes a display apparatus including an electrooptic element, a transistor, and a control circuit.

### SUMMARY OF THE INVENTION

However, it is necessary to further improve the performance of the display apparatus. Therefore, an objective is to improve the performance of the display apparatus.

Other problems and novel characteristics will be apparent from the descriptions of the specification and the accompanying drawings.

A display apparatus includes: a first substrate; a second substrate facing the first substrate; a liquid crystal layer provided between the first substrate and the second substrate; a heater having a terminal and overlapping a region where the liquid crystal layer is provided in plan view; a measurement circuit having a terminal electrically connectable to the terminal of the heater; a heater driving circuit having a terminal electrically connectable to the terminal of the heater; and a switch circuit, the switch circuit is capable of switching on and off of an electrical connection state between the terminal of the heater and the terminal of the measurement circuit and is capable of switching on and off of an electrical connection state between the terminal of the heater and the terminal of the heater driving circuit.

### BRIEF DESCRIPTIONS OF THE DRAWINGS

FIG. 1 is an explanatory diagram illustrating a positional relationship in a case where a viewer located on one surface side of a transparent display panel visually recognizes a background present on the opposite surface side thereof through a transparent display panel;

FIG. 2 is an explanatory diagram illustrating an example of the background visually recognized through the transparent display panel;

FIG. 3 is a plan view illustrating an example of a display apparatus;

FIG. 4 is a cross-sectional view illustrating an example of a display apparatus;

FIG. 5 is a circuit diagram illustrating an example of a measurement circuit in the display apparatus;

FIG. 6 is a circuit diagram illustrating an example of a measurement circuit in a display apparatus;

FIG. 7 is a circuit diagram illustrating an example of a pixel in a display apparatus;

FIG. 8 is a timing chart for describing an example of a method of driving a display apparatus;

FIG. 9 is a circuit diagram illustrating an example of a switch circuit in a display apparatus;

FIG. 10 is a circuit diagram illustrating an example of a switch circuit in a display apparatus;

FIG. 11 is a schematic view illustrating an example of a display apparatus; and

FIG. 12 is a schematic view illustrating an example of a display apparatus.

### DESCRIPTIONS OF THE PREFERRED EMBODIMENTS

The following is explanation for each embodiment of the present invention with reference to drawings. Note that only one example is disclosed, and appropriate modification with keeping the idea of the present invention which can be anticipated by those who are skilled in the art is obviously within the scope of the present invention. Also, in order to make the explanation clear, a width, a thickness, a shape, and others of each portion in the drawings are schematically illustrated more than those in an actual aspect in some cases. However, the illustration is only an example, and does not limit the interpretation of the present invention. In the present specification and each drawing, similar elements to those described earlier for the already-described drawings are denoted with the same or similar reference characters, and detailed explanation for them is appropriately omitted in some cases.

In the present application, the invention will be described in a plurality of sections or the like when required as a matter of convenience. However, these sections or the like are not irrelevant to each other unless otherwise stated. Regardless of before and after the description, one part of a simple example is a detailed part of, a part of or the entire part of a modification example of the other. Also, in principle, the repetitive description of the same part is omitted. Further, each element in the embodiment is not indispensable unless otherwise particularly stated not to be so, logically limited to the number, and clearly not to be so from the contexts.

Also, in the attached drawings, hatching or others is omitted even in a cross-sectional view in some cases such as a case of causing complication or a case of clearly distinguishing a portion from a space. In respect to this, a background outline is omitted even in a closed hole in a plan view when being clear from the explanation or others. Further, hatching or a dot pattern is added to a drawing in some cases even if the drawing is not a cross-sectional view in order to clearly show that the portion is not the space or clearly show a boundary between regions.

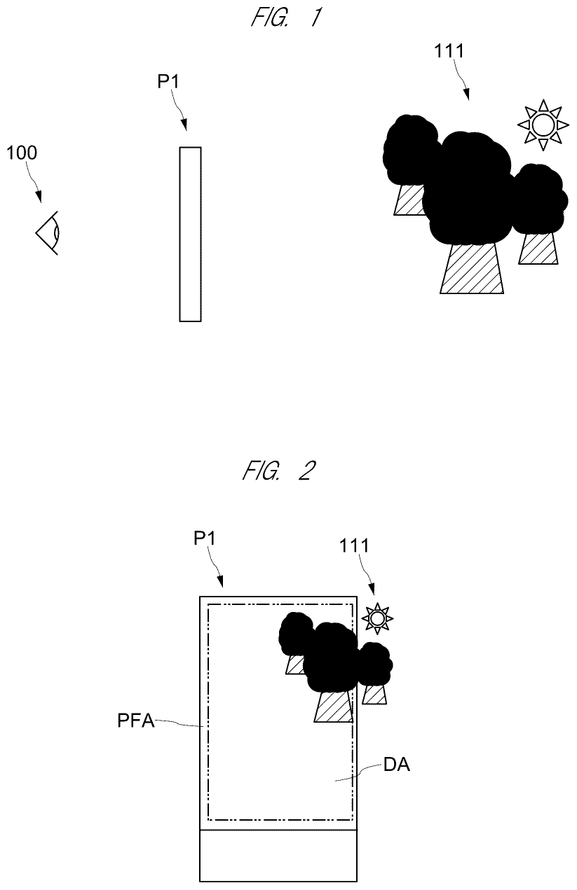

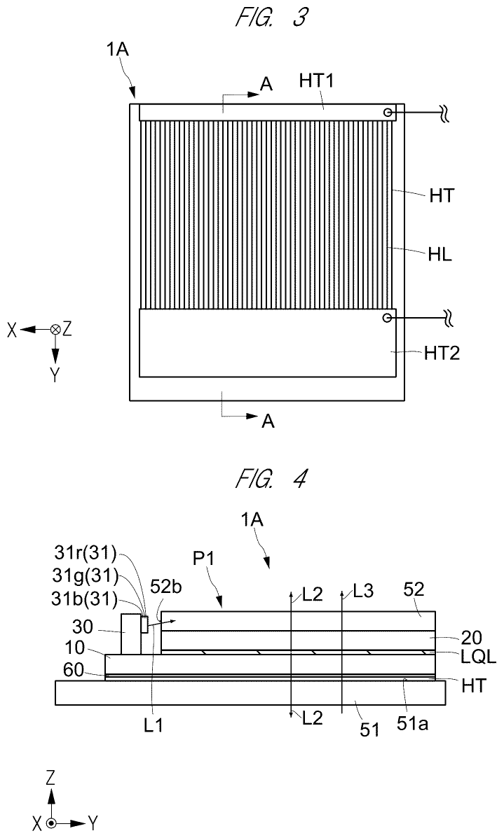

A display apparatus according to the present embodiment will be described. The display apparatus according to the present embodiment includes a transparent display panel. First, a property of the transparent display panel will be described. FIG. 1 is an explanatory diagram illustrating a positional relationship in a case where a viewer who is located on one surface side of the transparent display panel visually recognizes a background on the opposite surface side thereof through the transparent display panel. FIG. 2 is an explanatory diagram illustrating an example of the background visually recognized through the transparent display panel.

As illustrated in FIG. 1, when an observer 100 on one side of a display panel P1 views the other side thereof, a background 111 is visually recognized through the display panel P1. As illustrated in FIG. 2, if both a display region DA (PIX) and a peripheral region PFA outside the display region DA transmit light, the entire background 111 can be visually recognized without any uncomfortable feeling. On the other hand, if the peripheral region PFA has a light blocking property for preventing light transmission, a portion of the background 111 visually recognized through the display panel P1 is blocked by the peripheral region PFA, and therefore, the observer 100 may feel uncomfortable. Thus, in the case of the display panel P1 that is the transparent display panel, the display region DA and the peripheral region PFA preferably have visible-light transmission properties, respectively. From the viewpoint of the visual recognition of the background 111 without any comfortable feeling, the display region DA and the peripheral region PFA preferably have the respective visible-light transmission properties that are particularly substantially the same as each other.

As illustrated in FIG. 2, the display panel P1 includes the display region DA where an image is formed in response to an input signal fed from the outside, and the peripheral region (frame region) PFA located around the display region DA. The display region DA of the display panel P1 has, for example, a quadrangular shape. The display region DA of the display panel P1 may have a shape other than the quadrangular shape, such as a polygonal shape or a circular shape. In plan view in which a display surface is viewed, the display region DA is an effective region where the display panel P1 displays the image.

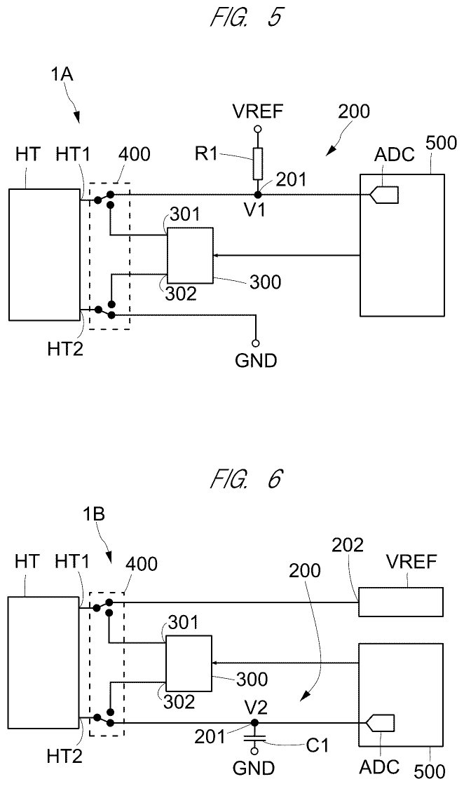

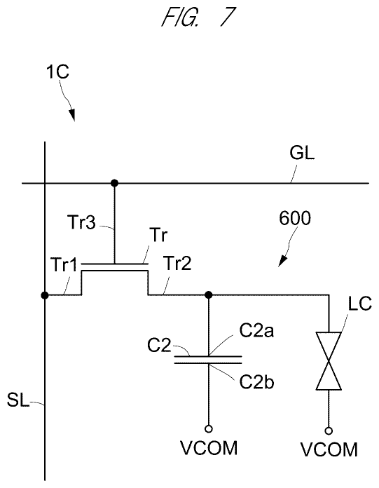

FIG. 3 is a plan view illustrating an example of a display apparatus. FIG. 4 is a cross-sectional view illustrating an example of the display apparatus. FIG. 4 is a cross-sectional view taken along a line A-A illustrated in FIG. 3. The following drawings including FIG. 3 will be explained in assumption that a direction along a thickness direction of the display apparatus 1A is a Z direction, and an extending direction of one side of the display apparatus 1A on an X-Y plane orthogonal to the Z direction is an X direction while a direction crossing the X direction is a Y direction. FIG. 5 is a circuit diagram illustrating an example of a measurement circuit of the display apparatus. The term “plan view of the display panel P1” means viewing the X-Y plane illustrated in FIG. 4 in plan view.

As illustrated in FIGS. 3 and 4, the display apparatus 1A according to the present embodiment includes the display panel P1, a light source 30, and a heater HT. As illustrated in FIG. 5, the display apparatus 1A further includes a measurement circuit 200, a heater driving circuit 300, and a switch circuit 400.

A configuration of the display apparatus 1A occasionally includes, for example, a flexible substrate connected to the display panel P1, a housing or others in addition to each component of the display panel P1 shown in FIG. 3. In FIG. 3, illustration of parts other than the display panel P1 is omitted. The display apparatus 1A according to the present embodiment does preferably not include a polarizing plate.

In FIG. 4, the display surface is parallel to the X-Y plane. In the example illustrated in FIG. 4, the light source 30 is mounted on the display panel P1. However, as a modification example, the light source 30 may be mounted on a light source substrate that is separate from the display panel P1 and is attached to the peripheral region PFA of the display panel P1 although not illustrated.

A configuration of the display panel P1 will be described. FIG. 4 is a cross-sectional view illustrating an example of the display apparatus. Although FIG. 4 is a cross-sectional view, hatching of each of members excluding a liquid crystal layer LQL is omitted.

As illustrated in FIG. 4, the display panel P1 includes an array substrate 10, a counter substrate 20, a front cover substrate 52, a back cover substrate 51, the liquid crystal layer LQL, and a planarizing layer 60.

The array substrate 10 can also be simply referred to as a substrate. However, the array substrate 10 will be described below while being interpreted as a substrate in which a plurality of switching elements are arranged in an array pattern. As illustrated in FIG. 4, the array substrate 10 has an upper surface and a lower surface on the opposite side to the upper surface. The upper surface of the array substrate 10 and the lower surface of the array substrate 10 are spaced apart from each other. The array substrate 10 has a side surface provided between the upper surface and the lower surface. In the present embodiment, the array substrate 10 is a TFT (thin film transistor) substrate. The array substrate 10 has, for example, a source wiring SL and a gate wiring GL. The array substrate 10 may be provided with a switching element (active element). The switching element is, for example, a transistor Tr. The thickness of the array substrate 10 is, for example, 0.1 mm or more and 10 mm or less.

As illustrated in FIG. 4, the counter substrate 20 is spaced apart from the array substrate 10. The counter substrate 20 can also be simply referred to as a substrate. However, the counter substrate 20 will be described below while being interpreted as a substrate arranged at a position facing the array substrate 10. The counter substrate 20 has an upper surface and a lower surface on the opposite side to the upper surface. The upper surface of the counter substrate 20 and the lower surface of the counter substrate 20 are spaced apart from each other. The counter substrate 20 has a side surface provided between the upper surface and the lower surface. As illustrated in FIG. 4, the lower surface of the counter substrate 20 and the upper surface of the array substrate 10 face each other. The counter substrate 20 has a visible-light transmission property. The thickness of the counter substrate 20 is, for example, 0.1 mm or more and 10 mm or less.

The counter substrate 20 is bonded to, for example, the array substrate 10 via a sealing portion (sealing material). The sealing portion (sealing material) bonds the array substrate 10 and the counter substrate 20 to each other. The sealing portion bonds the upper surface of the array substrate 10 and the lower surface of the counter substrate 20 to each other. The sealing portion is arranged to, for example, surround the outer periphery of the liquid crystal layer LQL. The sealing portion surrounds the entire liquid crystal layer LQL, together with the array substrate 10 and the counter substrate 20. In other words, the liquid crystal layer LQL is inside the sealing portion. The sealing portion plays a role of a sealing for sealing the liquid crystal layer LQL into the gap between the array substrate 10 and the counter substrate 20. Also, the sealing portion plays a role of a bonding member for bonding the array substrate 10 and the counter substrate 20 to each other.

As illustrated in FIG. 4, the liquid crystal layer LQL is provided between the upper surface of the array substrate 10 and the lower surface of the counter substrate 20. The liquid crystal layer LQL includes a liquid crystal LC. The liquid crystal layer LQL is an optical modulation element capable of changing a light transmission state by electrically driving an orientation state of the liquid crystal LC. The display panel P1 has a function of driving an orientation state of liquid crystal molecules and modulating light L1 that passes therethrough by controlling a state of an electric field formed around the liquid crystal layer LQL via the above-described switching element.

The liquid crystal LC is a polymer dispersed liquid crystal LC, and contains liquid crystalline polymers and liquid crystal molecules. The liquid crystalline polymers are formed in a stripe pattern, and the liquid crystal molecules are dispersed into gaps among the liquid crystalline polymers. The liquid crystalline polymers and the liquid crystal molecules each have optical anisotropy or refractivity anisotropy. Responsiveness of the liquid crystalline polymers to the electric field is lower than responsiveness of the liquid crystal molecules to the electric field. An orientation direction of the liquid crystalline polymers hardly changes regardless of the presence or absence of the electric field.

On the other hand, an orientation direction of the liquid crystal molecules varies depending on the electric field when a voltage equal to or higher than a threshold value is applied to the liquid crystal LC. When no voltage is applied to the liquid crystal LC, optical axes of the liquid crystalline polymers and the liquid crystal molecules are parallel to each other. Therefore, the light L1 having entered the liquid crystal layer LQL is hardly dispersed in the liquid crystal layer LQL, and penetrates therethrough (transparent state). When the voltage is applied to the liquid crystal LC, the optical axes of the liquid crystalline polymers and the liquid crystal molecules cross each other. Therefore, the light L1 having entered the liquid crystal LC is dispersed in the liquid crystal layer LQL (dispersion state).

The display panel P1 control the transparent state and the dispersion state by controlling an orientation of the liquid crystal LC in a propagation path of the light L1. In the dispersion state, by the liquid crystal LC, the light L1 is emitted as emitted light L2 from the upper surface side of the front cover substrate 52 to outside the display panel P1. Background light L3 having emitted from the lower surface side of the back cover substrate 51 is transmitted through the array substrate 10, the liquid crystal layer LQL, the counter substrate 20, the front cover substrate 52, and the like, and is emitted to outside from an upper surface of the front cover substrate 52. The emitted light L2 and the background light L3 are visually recognized by the observer located on the upper surface side of the front cover substrate 52. The observer can recognize the emitted light L2 and the background light L3 in combination. Thus, the transparent display panel P1 is the display panel P1 through which the observer can recognize the display image and the background to overlap each other.

As illustrated in FIG. 4, the back cover substrate 51 has an upper surface and a lower surface on the opposite side to the upper surface. The back cover substrate 51 and the front cover substrate 52 described below can be each simply referred to as a substrate. However, the back cover substrate 51 and the front cover substrate 52 will be described below to be distinguished from each other. The upper surface of the back cover substrate 51 and the lower surface of the back cover substrate 51 are spaced apart from each other. The back cover substrate 51 has a side surface provided between the upper surface and the lower surface. In the present embodiment, the back cover substrate 51 is made of glass. In other words, the back cover substrate 51 is a glass substrate made of glass. The back cover substrate 51 has a visible-light transmission property. Examples of a material for the back cover substrate 51 are organic materials such as acrylic resin or polycarbonate resin in addition to glass. The thickness of the back cover substrate 51 is, for example, 0.5 mm or more and 10 mm or less.

As illustrated in FIG. 3, the heater HT has a heater wiring HL, an electrode (terminal) HT1, and an electrode (terminal) HT2. The heater HT has a plurality of heater wirings HL.

As illustrated in FIG. 3, the heater wiring HL is provided in the Y-direction. That is, in plan view of the display panel P1, the heater wiring HL is parallel to a light incident direction. Here, the light incident direction is a direction in which light emitted from the light source 30 is incident on the display panel P1 in plan view of the display panel P1. In the examples illustrated in FIGS. 3 and 4, the light incident direction means a direction in which light emitted from the light source 30 is incident on a side surface of the front cover substrate 52 in plan view of the display panel P1. That is, the light incident direction in the example illustrated in FIG. 3 is the Y-direction.

As illustrated in FIG. 3, the heater wiring HL is electrically connected to the electrode HT1 and the electrode HT2. That is, when a voltage is applied between the electrode HT1 and the electrode HT2, a current flows through the heater wiring HL.

As illustrated in FIG. 4, the heater wiring HL is provided on an upper surface 51a of the back cover substrate 51. The heater wiring HL is in contact with the upper surface 51a of the back cover substrate 51. The heater wiring HL contains a metal. The heater wiring HL contains, for example, a single metal or an alloy. Examples of the single metal are copper and aluminum. An example of the alloy is an Al alloy (aluminum alloy). The heater wiring HL can include not only a single layer but also a plurality of layers. The heater wiring HL includes, for example, a metal wire and a covering layer that covers an outer surface of the metal wire. The same material as that for the heater wiring HL can be used for the electrode HT1 and the electrode HT2. Since the heater wiring contains the metal, the power consumption of the heater can be reduced. Also, since the heater wiring contains the metal, the response speed of the heater can be improved.

The heater wiring HL is a heating device using a resistance heating method. That is, when the current flows through the heater wiring HL, the heater wiring HL can generate heat. In plan view of the display panel P1, the width of the heater wiring HL is, for example, 0.05 μm or more and 10 μm or less. The thickness of the heater wiring HL is preferably 1 μm or more and 5 μm or less. When the thickness of the heater wiring HL is 5 μm or less, the resistance of the heater wiring HL can be reduced. Thus, the current flowing through the heater wiring HL can be made large even by the same applied voltage. Therefore, the heating capability of the heater wiring HL can be further increased. The thickness of the heater wiring HL is more preferably 0.1 μm or more and 1 μm or less, and still more preferably 0.3 μm or more and 0.7 μm or less. Thus, the light emitted from the light source 30 is difficult to be dispersed because of the heater wiring HL.

The planarizing layer 60 is provided on the upper surface 51a of the back cover substrate 51. The planarizing layer 60 is provided to cover the heater wiring HL. The planarizing layer 60 has an upper surface and a lower surface on the opposite side to the upper surface. The lower surface of the planarizing layer 60 is in contact with the upper surface 51a of the back cover substrate 51. Since the planarizing layer 60 covers the heater wiring HL, the upper surface of the planarizing layer 60 and the heater wiring HL are spaced apart from each other. That is, the thickness of the planarizing layer 60 is larger than the thickness of the heater wiring HL. Thus, the heater wiring HL can be protected. Therefore, the heater wiring HL containing the metal can be prevented from corroding. When the heater wiring HL is provided on the upper surface 51a of the back cover substrate 51, a step is formed. Since the planarizing layer 60 is provided to cover the heater wiring HL, the step can be reduced. Thus, the back cover substrate 51 provided with the heater wiring HL can be easily bonded to another base material. The thickness of the planarizing layer 60 is preferably equal to or larger than one time and equal to or smaller than 10 times the thickness of the heater wiring HL, and more preferably equal to or larger than 1.5 times and equal to or smaller than 5 times the thickness. Thus, the thickness of the display panel P1 can be reduced.

In the display apparatus 1A of an edge light type, there is a possibility that the planarizing layer 60 transmits the light a plurality of times. Therefore, the planarizing layer 60 is preferably made of a material that absorbs the light as much as possible as well as having a small wavelength dispersion. The planarizing layer 60 is formed to cover a base substrate (e.g., the back cover substrate 51) in which a pattern (e.g., the heater wiring HL) is formed. The planarizing layer 60 is, for example, an insulating layer made of an organic insulating material. The planarizing layer 60 has a function of planarizing the surface asperity caused by the pattern formed on the base substrate. In the example illustrated in FIG. 4, the planarizing layer 60 is also referred to as an overcoat layer.

As illustrated in FIG. 4, the front cover substrate 52 has an upper surface and a lower surface on the opposite side to the upper surface. The upper surface and the lower surface are spaced apart from each other. The front cover substrate 52 has a side surface 52b provided between the upper surface and the lower surface. In the example illustrated in FIG. 4, the side surface 52b of the front cover substrate 52 functions as a light incident surface for guiding the light into the front cover substrate 52. The front cover substrate 52 functions as a light guide plate. The side surface 52b of the front cover substrate 52 faces the light source 30. In the present embodiment, in plan view of the display panel P1, light emitted from the light source 30 travels in the Y-direction illustrated in FIG. 4.

In the present embodiment, the front cover substrate 52 is made of glass. In other words, the front cover substrate 52 is a glass substrate made of glass. The front cover substrate 52 has a visible-light transmission property. Examples of a material for the front cover substrate 52 are organic materials such as acrylic resin or polycarbonate resin in addition to glass. A bonding layer can be provided between the front cover substrate 52 and the counter substrate 20.

In the present embodiment, the measurement circuit 200 is a temperature measurement circuit. The present embodiment can be configured so that a temperature is calculated from a physical quantity measured by the measurement circuit 200. Examples of the physical quantity measured by the measurement circuit 200 are a current and a voltage. As illustrated in FIG. 5, the measurement circuit 200 includes a resistor R1, an A/D converter (analog/digital converter) ADC, and a power supply VREF. The measurement circuit 200 has a terminal 201. One of terminals of the resistor R1 is electrically connectable to the electrode HT1 of the heater HT via the switch circuit 400. The other terminal of the resistor R1 is electrically connected to the power supply VREF. In the example illustrated in FIG. 5, the one terminal of the resistor R1 is equivalent to the terminal 201 of the measurement circuit 200. The A/D converter ADC is electrically connectable to the electrode HT1 of the heater via the switch circuit 400. The resistor R1 and the A/D converter ADC are connected in parallel with the electrode HT1 of the heater HT. The electrode HT2 of the heater is electrically connectable to a reference potential GND via the switch circuit 400. The reference potential GND is, for example, a ground potential. In the example illustrated in FIG. 5, the measurement circuit 200 diverts the A/D converter ADC of a control circuit 500. The measurement circuit 200 may be also provided with an A/D converter ADC in addition to the A/D converter ADC of the control circuit 500. Although the reference potential GND is not included in the measurement circuit 200 in the example illustrated in FIG. 5, the reference potential GND can be included in a part of the measurement circuit 200.

The power supply VREF can apply a constant voltage to the other terminal of the resistor R1. The power supply VREF is, for example, a constant voltage power supply. The A/D converter ADC can measure a voltage value V1 applied between the one terminal of the resistor R1 and the switch circuit 400.

The voltage value V1 at the one terminal of the resistor R1 relative to the reference potential GND changes depending on a resistance value of the heater HT when the one terminal of the resistor R1 is electrically connected to the electrode HT1 of the heater HT while the electrode HT2 of the heater HT is electrically connected to the reference potential GND. The resistance value of the heater HT changes depending on a temperature of the heater HT. Therefore, the voltage value V1 is measured using the A/D converter ADC, thereby measuring the temperature of the heater HT.

The heater driving circuit 300 has a terminal 301 and a terminal 302. The heater driving circuit 300 is electrically connectable to the electrode HT1 of the heater HT and the electrode HT2 of the heater HT via the switch circuit 400. The terminal 301 of the heater driving circuit 300 is electrically connectable to the electrode HT1 of the heater HT. The terminal 302 of the heater driving circuit 300 is electrically connectable to the electrode HT2 of the heater HT. The heater driving circuit 300 can apply a voltage, for example, to a gap between the electrode HT1 of the heater HT and the electrode HT2 of the heater HT in response to a signal transmitted from the control circuit 500. Thus, a current flows through the heater wiring HL of the heater HT, thereby increasing the temperature of the heater wiring HL.

The switch circuit 400 can switch on and off of an electrical connection state between the electrode HT1 of the heater HT and the one terminal of the resistor R1 of the measurement circuit 200. The switch circuit 400 can switch on and off of an electrical connection state between the electrode HT1 of the heater HT and the terminal 301 of the heater driving circuit 300. The switch circuit 400 can switch on and off of an electrical connection state between the electrode HT2 of the heater HT and the terminal 302 of the heater driving circuit 300. Further, the switch circuit 400 can switch on and off of an electrical connection state between the electrode HT2 of the heater HT and the reference potential GND.

The switch circuit 400 can perform switching such that the electrode HT1 of the heater HT is electrically connected to either the measurement circuit 200 or the heater driving circuit 300. The switch circuit 400 can perform switching such that the electrode HT1 of the heater HT is neither electrically connected to the measurement circuit 200 nor the heater driving circuit 300. That is, the switch circuit 400 can perform switching among three states, i.e., a state where the electrode HT1 of the heater HT is electrically connected to only the measurement circuit 200, a state where the electrode HT1 of the heater HT is electrically connected to only the heater driving circuit 300, and a state where the electrode HT1 of the heater HT is neither electrically connected to the measurement circuit 200 nor the heater driving circuit 300.

The switch circuit 400 can switch on and off of the electrical connection state between the electrode HT2 of the heater HT and the reference potential GND. The switch circuit 400 can perform switching such that the electrode HT2 of the heater HT is electrically connected to either the ground potential GND or the heater driving circuit 300. The switch circuit 400 can perform switching such that the electrode HT2 of the heater HT is neither electrically connected to the reference potential GND nor the heater driving circuit 300. That is, the switch circuit 400 can perform switching among three states, i.e., a state where the electrode HT2 of the heater HT is electrically connected to only the reference potential GND, a state where the electrode HT2 of the heater HT is electrically connected to only the heater driving circuit 300, and a state where the electrode HT2 of the heater HT is neither electrically connected to the reference potential GND nor the heater driving circuit 300.

The switch circuit 400 switches on and off of the electrical connection state in response to, for example, a signal transmitted from the control circuit 500.

The control circuit 500 performs control such that the electrical connection state between the electrode HT1 of the heater HT and the terminal 301 of the heater driving circuit 300 is turned off when the electrical connection state between the electrode HT1 of the heater HT and the one terminal of the resistor R1 of the measurement circuit 200 is on. The control circuit 500 performs control such that the electrical connection state between the electrode HT1 of the heater HT and the one terminal of the resistor R1 of the measurement circuit 200 is turned off when the electrical connection state between the electrode HT1 of the heater HT and the terminal 301 of the heater driving circuit 300 is on. The control circuit 500 performs control such that the electrical connection state between the electrode HT2 of the heater HT and the terminal 302 of the heater driving circuit 300 is turned off when the electrical connection state between the electrode HT2 of the heater HT and the reference potential GND is on. The control circuit 500 performs control such that the electrical connection state between the electrode HT2 of the heater HT and the reference potential GND is turned off when the electrical connection state between the electrode HT2 of the heater HT and the terminal 302 of the heater driving circuit 300 is on.

The control circuit 500 controls the heater driving circuit 300, based on a measurement result of the measurement circuit 200. For example, if the temperature of the heater HT measured by the measurement circuit 200 is higher than a specified value, the control circuit 500 performs control to decrease an output voltage of the heater driving circuit 300. Alternatively, if the temperature of the heater HT measured by the measurement circuit 200 is lower than the specified value, the control circuit 500 performs control to increase the output voltage of the heater driving circuit 300. The output voltage is, for example, a voltage applied between the electrode HT1 and the electrode HT2 of the heater HT. The control circuit 500 is, for example, a microcomputer.

A configuration of the light source 30 will be described. As illustrated in FIG. 4, the light source 30 is provided at a position facing the side surface 52b of the front cover substrate 52. The light source 30 includes, for example, a light source 31 and a lens although not particularly limited. The light source 31 includes, for example, a red light source 31r, a green light source 31g, and a blue light source 31b. Each of the red light source 31r, the green light source 31g, and the blue light source 31b is made of, for example, a plurality of light emitting diode elements. The lens is arranged, for example, between the side surface 52b of the front cover substrate 52 illustrated in FIG. 4 and the plurality of light emitting diode elements. The plurality of light emitting diode elements include a light emitting diode element capable of emitting light of a first color (e.g., a red color), a light emitting diode element capable of emitting light of a second color (e.g., a green color) different from the first color, and a light emitting diode element capable of emitting light of a third color (e.g., a blue color) different from the first color and the second color. The plurality of light emitting diode elements are arranged in the X-direction along the side surface 52b of the front cover substrate 52.

In the case of the display apparatus 1A that performs color display, for example, lighting and non-lighting of the light source 31 are controlled. In one display period DF1, light emission from the red light source 31r, the green light source 31g, and the blue light source 31b are respectively performed at different timings from one another.

When the white balance of the display apparatus 1A is adjusted, the luminance of the light emitting diode element of each color is adjusted based on the chromaticity of the single color of RGB colors. Specifically, in the adjustment of the white balance, respective currents input to the red light source 31r, the green light source 31g, and the blue light source 31b and respective lighting time periods thereof are adjusted to reduce variation in the luminance of each of the RGB colors in the display time period.

The foregoing is the explanation of the example in which the light source 30 is provided at the position facing the side surface 52b of the front cover substrate 52. The arrangement of the light source 30 is not particularly limited, and the light source 30 may be provided at a position facing the side surface of the back cover substrate 51 or a position facing a side surface of the counter substrate 20.

Next, an effect of the display apparatus 1A according to the present embodiment will be described. In a transparent display, color image display is generally performed by field sequential driving using LEDs of the three RGB colors. The lower an environmental temperature is, the lower a rising response speed of the liquid crystal LC is. Thus, the luminance of the display starts to decrease. Also, the lower the environmental temperature is, the lower a falling response speed of the liquid crystal LC also is. Thus, lighting is also continued in a lighting period for an LED of a color of a next frame. Therefore, color mixing may occur. The lower temperature causes a higher possibility of change of the image display to monochrome display.

As a countermeasure to the luminance reduction and the monochrome display, improvement of the response speed of the liquid crystal LC is conceivable. For the improvement of the response speed of the liquid crystal LC, a method of warming the liquid crystal LC is conceivable. As the method of warming the liquid crystal LC, increase in the temperature of the liquid crystal LC by the heater HT is conceivable. As a method for improving the heating accuracy of the heater HT, a method of feedback by measuring the temperature of the display apparatus 1A by using a sensor is conceivable. However, when a temperature sensor is provided in order to measure the temperature of the display apparatus 1A, the temperature sensor overlaps a region of the display apparatus 1A where the liquid crystal LC is provided in plan view. Therefore, the temperature sensor becomes an obstacle, thereby causing a possibility of decrease in the visibility of the display apparatus 1A.

The display apparatus 1A according to the present embodiment measures the temperature of the liquid crystal LC of the display apparatus 1A by using the heater HT. Thus, it is unnecessary to separately provide components of the temperature sensor in the region of the display apparatus 1A where the liquid crystal LC is provided in plan view in order to measure the temperature of the liquid crystal LC of the display apparatus 1A. Therefore, the decrease in the visibility of the display apparatus 1A can be prevented. Since the temperature of the liquid crystal LC of the display apparatus 1A can be measured by using the heater HT, the feedback control for the heater can be performed based on the measurement result. As a result, the heating accuracy of the heater HT can be improved.

### Modification Example

A modification example of the display apparatus according to the present embodiment will be described. Note that the same components are denoted by the same reference symbol, and the description thereof is omitted.

FIG. 6 is a circuit diagram illustrating an example of a measurement circuit of a display apparatus 1B. The measurement circuit 200 illustrated in FIG. 6 is a temperature measurement circuit. The measurement circuit 200 illustrated in FIG. 6 differs from the measurement circuit illustrated in FIG. 5 in that it includes a power supply VREF, a capacitor C1, and an A/D converter ADC. The measurement circuit 200 illustrated in FIG. 6 has a terminal 201 and a terminal 202.

A terminal of the power supply VREF is electrically connectable to the electrode HT1 of the heater HT via the switch circuit 400. In the example illustrated in FIG. 6, the terminal of the power supply VREF is equivalent to the terminal 201 of the measurement circuit 200. One of terminals of the capacitor C1 is electrically connectable to an electrode HT2 of the heater HT via the switch circuit 400. In the example illustrated in FIG. 6, the one terminal of the capacitor C1 is equivalent to the terminal 202 of the measurement circuit 200. The other terminal of the capacitor C1 is electrically connected to the reference potential GND. The A/D converter ADC is electrically connectable to the electrode HT2 of the heater HT via the switch circuit 400. The other terminal of the capacitor C1 and the A/D converter ADC are connected in parallel with the electrode HT2 of the heater. The reference potential GND is, for example, a ground potential.

The power supply VREF can apply a voltage to the electrode HT1 of the heater HT. The power supply VREF is, for example, a constant voltage power supply. The A/D converter ADC can measure a voltage value V2 applied between the electrode HT2 of the heater HT and the switch circuit 400.

The capacitor C1 is charged when the power supply VREF is electrically connected to electrode HT1 of the heater HT while the electrode HT2 of the heater HT is electrically connected to the one terminal of the capacitor C1. The voltage value V2 at the one terminal of the capacitor C1 relative to the reference potential GND at the time of completion of the charging of the capacitor C1 changes depending on a resistance value of the heater HT. The resistance value of the heater HT changes depending on a temperature of the heater HT. Therefore, the temperature of the heater HT can be measured by measuring the voltage value V2 by using the A/D converter ADC. Further, a time period taken from the start of the charging of the capacitor C1 to the completion of the charging changes depending on the resistance value of the heater HT. Therefore, by measuring the time taken from the start of the charging of the capacitor C1 to the completion of the charging, the temperature of the heater HT can also be measured.

The switch circuit 400 can switch on and off of an electrical connection state between the electrode HT1 of the heater and the measurement circuit 200. The switch circuit 400 can switch on and off of an electrical connection state between the electrode HT2 of the heater HT and the measurement circuit 200. In the example illustrated in FIG. 6, the switch circuit 400 can switch on and off of an electrical connection state between the electrode HT1 of the heater HT and the power supply VREF. The switch circuit 400 can switch on and off of an electrical connection state between the electrode HT2 of the heater HT and the one terminal of the capacitor C1.

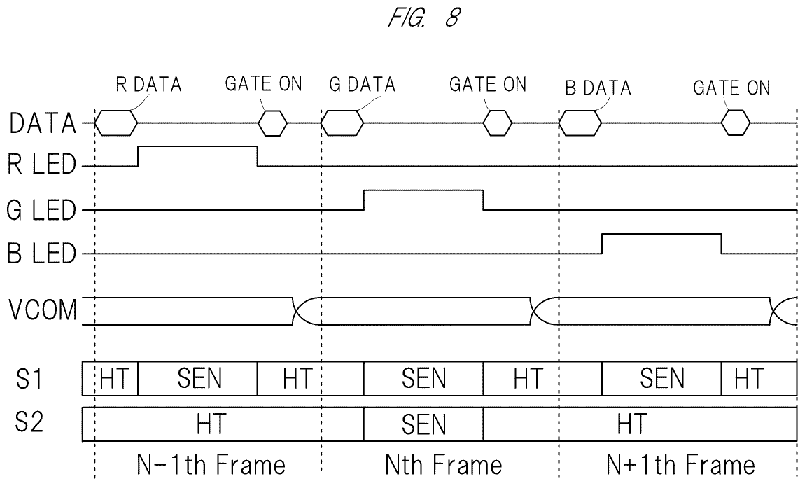

FIG. 7 is a circuit diagram illustrating an example of a pixel of a display apparatus. As illustrated in FIG. 7, a pixel 600 of a display apparatus 1C includes a transistor Tr, a capacitor C2, and a liquid crystal LC. The transistor Tr has a terminal Tr1, a terminal Tr2, and a terminal Tr3. The capacitor C2 has a terminal C2a and a terminal C2b.

The terminal Tr1 of the transistor is electrically connected to a source wiring SL. The terminal Tr3 of the transistor is electrically connected to a gate wiring GL. The terminal Tr2 of the transistor is electrically connected to the terminal C2a of the capacitor. The terminal C2b of the capacitor is electrically connected to a common electrode VCOM. One of terminals of the liquid crystal LC is electrically connected to the terminal Tr2 of the transistor. The other terminal of the liquid crystal LC is electrically connected to the common electrode VCOM. The terminal C2a of the capacitor and the one terminal of the liquid crystal LC are connected in parallel with the terminal Tr2 of the transistor. The terminal Tr1 of the transistor Tr is, for example, a source. The terminal Tr2 of the transistor Tr is, for example, a drain. The terminal Tr3 of the transistor Tr is, for example, a gate. The common electrode VCOM is shared among a plurality of the pixels 600.

The source wiring SL is provided on, for example, the upper surface of the array substrate 10 illustrated in FIG. 4. The source wiring SL is, for example, in contact with the upper surface of the array substrate 10 illustrated in FIG. 4. The array substrate 10 has a visible-light transmission property. The source wiring SL is a wiring for transmitting a video signal.

In plan view of the display panel P1, the light emitted from the light source 30 apparently travels in the Y-direction. The source wiring SL is provided in, for example, the Y-direction. That is, in plan view of the display panel P1, the source wiring SL is provided in the travelling direction of the light emitted from the light source 30. In plan view of the display panel P1, the gate wiring GL is provided to, for example, intersect the source wiring SL. The gate wiring GL is a wiring for transmitting a scan signal. In the present embodiment, the source wiring SL and the gate wiring GL are perpendicular to each other. The source wiring SL and the gate wiring GL are spaced apart from each other. The source wiring SL is electrically separated from the gate wiring GL.

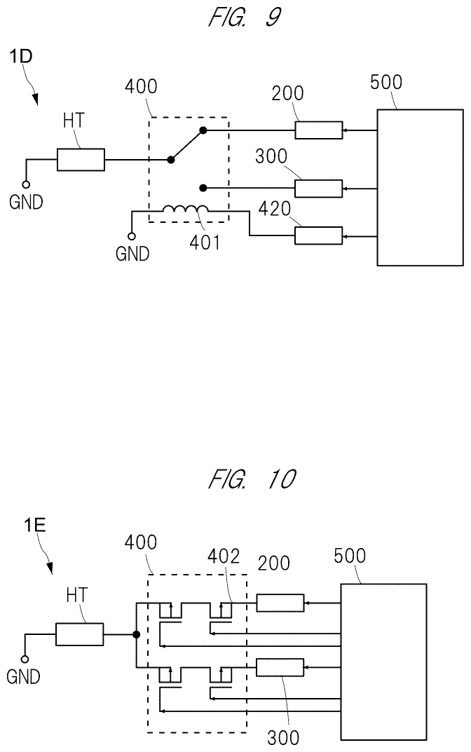

Next, an example of a method of driving the display apparatus 1A will be described. FIG. 8 is a timing chart for describing the example of the method of driving the display apparatus 1A. FIG. 8 illustrates a timing chart of an (N−1)-th frame, an N-th frame, and an (N+1)-th frame. A term “DATA” shows a chart illustrating a main signal supplied to the pixel 600. A term “R LED” shows a signal line that controls on and off of an electrical connection state of the red light source 31r of the light source 31. A term “G LED” shows a signal line that controls on and off of an electrical connection state of the green light source 31g of the light source 31. A term “B LED” shows a signal line that controls on and off of an electrical connection state of the blue light source 31b of the light source 31. A term “VCOM” shows a signal line that supplies a voltage to the common electrode VCOM. A term “S1” shows an example of a chart illustrating a period during which the heater driving circuit 300 or the measurement circuit is electrically connected to the heater. In FIG. 8, a period during which the heater driving circuit 300 is electrically connected to the heater HT is described as “HT”. A period during which the measurement circuit 200 is electrically connected to the heater HT is described as “SEN”. A term “S2” shows another example of the chart illustrating the period during which the heater driving circuit 300 or the measurement circuit 200 is electrically connected to the heater HT.

As illustrated in FIG. 8, in the (N−1)-th frame, a charge “R DATA” is first written into the pixel 600. Then, the electrical connection state of the red light source 31r is turned on. Thus, the pixel 600 displays a red color. After the electrical connection state of the red light source 31r is turned off, the pixel 600 is reset by collective gate turning on (GATE ON). After the pixel 600 is reset, common inversion is performed. By the common inversion, a maximum value of an amplitude of a signal supplied to the common electrode VCOM and a minimum value of the amplitude are switched.

As illustrated in FIG. 8, in the N-th frame, a charge “G DATA” is first written into the pixel 600. Then, the electrical connection state of the green light source 31g is turned on. Thus, the pixel 600 displays a green color. After the electrical connection state of the green light source 31g is turned off, the pixel 600 is reset by collective gate turning on (GATE ON). After the pixel 600 is reset, common inversion is performed. By the common inversion, a maximum value of an amplitude of a signal supplied to the common electrode VCOM and a minimum value of the amplitude are switched.

As illustrated in FIG. 8, in the (N+1)-th frame, a charge “B DATA” is first written into the pixel 600. Then, the electrical connection state of the blue light source 31b is turned on. Thus, the pixel 600 displays a blue color. After the electrical connection state of the blue light source 31b is turned off, the pixel 600 is reset by collective gate turning on (GATE ON). After the pixel 600 is reset, common inversion is performed. By the common inversion, a maximum value of an amplitude of a signal supplied to the common electrode VCOM and a minimum value of the amplitude are switched.

In S1, when the respective electrical connection states of the red light source 31r, the green light source 31g, and the blue light source 31b are on, the measurement circuit 200 is electrically connected to the heater HT. When the respective electrical connection states of the red light source 31r, the green light source 31g, and the blue light source 31b are on, the heater driving circuit 300 is electrically separated from the heater HT.

In S1, when the respective electrical connection states of the red light source 31r, the green light source 31g, and the blue light source 31b are off, the heater driving circuit 300 is electrically connected to the heater HT. When the respective electrical connection states of the red light source 31r, the green light source 31g, and the blue light source 31b are off, the measurement circuit 200 is electrically separated from the heater HT.

That is, in S1, when the respective electrical connection states of the red light source 31r, the green light source 31g, and the blue light source 31b are on, a temperature is measured. When the respective electrical connection states of the red light source 31r, the green light source 31g, and the blue light source 31b are off, heating is performed.

When the respective electrical connection states of the red light source 31r, the green light source 31g, and the blue light source 31b are on, noise of a circuit in the display apparatus tends to decrease. When the respective electrical connection states of the red light source 31r, the green light source 31g, and the blue light source 31b are on, the temperature of the heater HT is measured, thereby improving the measurement accuracy of the temperature.

S2 differs from S1 in that the measurement circuit 200 is electrically connected to the heater HT only in the N-th frame. In the (N−1)-th frame and the (N+1)-th frame, the measurement circuit 200 is electrically separated from the heater HT. In the (N−1)-th frame and the (N+1)-th frame, the heater driving circuit 300 is electrically connected to the heater HT. Thus, a time period during which the heater HT performs heating can be lengthened. As a result, the heating performance of the heater HT can be improved.

When the respective electrical connection states of the red light source 31r, the green light source 31g, and the blue light source 31b are on, control can be performed to the state where the measurement circuit 200 is electrically separated from the heater HT. When the respective electrical connection states of the red light source 31r, the green light source 31g, and the blue light source 31b are on, control can be performed to the state where the heater driving circuit 300 is electrically connected to the heater HT.

FIG. 9 is a circuit diagram illustrating an example of a switch circuit of a display apparatus. As illustrated in FIG. 9, a switch circuit 400 of a display apparatus 1D includes a relay 401. A relay power supply 420 can apply a voltage to the relay 401. A control circuit 500 controls a voltage value applied to the relay 401 by the relay power supply 420. Thus, the on and the off of the electrical connection state between a heater HT and the measurement circuit 200 can be switched. Also, the on and off of the electrical connection state between the heater HT and a heater driving circuit 300 can be switched.

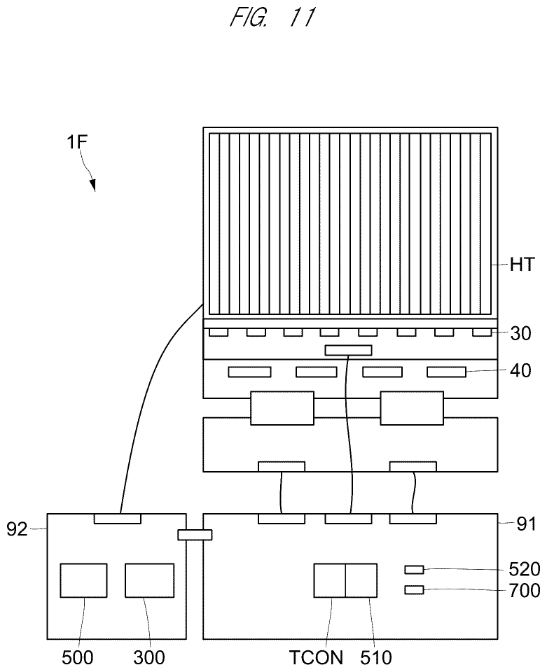

FIG. 10 is a circuit diagram illustrating an example of a switch circuit of a display apparatus. As illustrated in FIG. 10, a switch circuit 400 of a display apparatus 1E includes a MOS transistor 402. The MOS transistor 402 is, for example, a MOSFET. In FIG. 10, the switch circuit 400 includes a plurality of the MOS transistors 402. A source and a drain of the MOS transistor 402 are connected in series between the heater HT and the measurement circuit 200. The source and the drain of the MOS transistor 402 are connected in series between the heater HT and a heater driving circuit 300. A control circuit 500 can perform switching between on and off of an electrical connection state between the source and the drain by controlling the gate of the MOS transistor 402.

The switch circuit 400 is not limited to the examples illustrated in FIGS. 9 and 10, but another method for electrically switching the connection between the heater HT and the measurement circuit 200 and the connection between the heater HT and the heater driving circuit 300 can be used.

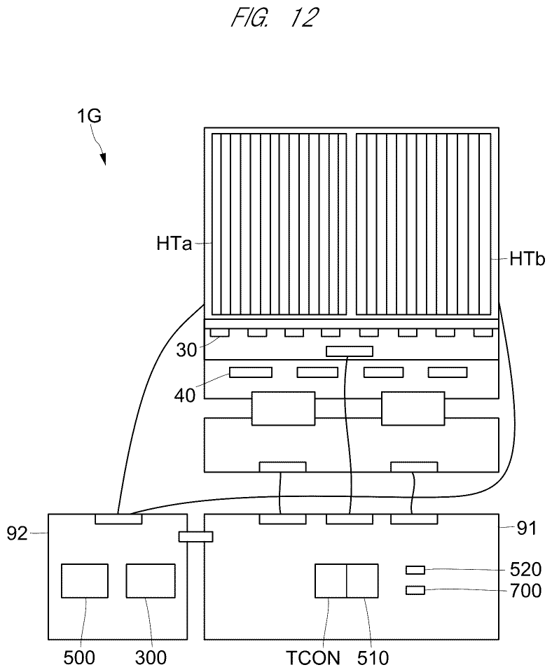

FIG. 11 is a schematic view illustrating an example of a display apparatus. As illustrated in FIG. 11, a display apparatus 1F further includes a substrate 91 and a substrate 92. A display panel P1 of the display apparatus 1F includes the light source 30, the heater HT, and the driving circuit 40. An image processing part 510, a timing controller TCON, a light source driving circuit 520, and a power supply generating part 700 are provided on the substrate 91. The image processing part 510 and the timing controller TCON are integrally provided. The control circuit 500 and the heater driving circuit 300 are provided on the substrate 92. The image processing part 510, the timing controller TCON, the light source driving circuit 520, and the power supply generating part 700, which are provided on the substrate 91, are electrically connectable to the light source 30, the heater HT, and the driving circuit 40, which are provided on the display panel P1, via a connector. The control circuit 500 and the heater driving circuit 300, which are provided on the substrate 92, are electrically connectable to the light source 30, the heater HT, and the driving circuit 40, which are provided on the display panel P1, via a connector. The substrate 91 and the substrate 92 can be integrated as one substrate. As illustrated in FIG. 11 and FIG. 12 described below, the substrate 91 and the substrate 92 are preferably electrically connected to each other when the substrate 91 on which the control circuit 500 and the heater driving circuit 300 are mounted and the substrate 92 on which the timing controller TCON is mounted are separated from each other. This is for achieving synchronization between an operation of the timing controller TCON and an operation of the control circuit 500 or the heater driving circuit 300.

The light source driving circuit 520 transmits a signal to, for example, the driving circuit 40. The driving circuit 40 transmits a signal to, for example, the light source 30 in response to the signal transmitted from the light source driving circuit 520. Specifically, the driving circuit 40 outputs a signal for controlling lighting and non-lighting of the red light source 31r to the red light source 31r, outputs a signal for controlling lighting and non-lighting of the green light source 31g to the green light source 31g, and outputs a signal for controlling lighting and non-lighting of the blue light source 31b to the blue light source 31b. The driving circuit 40 is, for example, a driver IC.

FIG. 12 is a schematic view illustrating an example of a display apparatus. A display apparatus 1G illustrated in FIG. 12 differs from the display apparatus 1F illustrated in FIG. 11 in that it includes a plurality of the heaters HT. The plurality of heaters HT are independently driven. That is, different voltages from one another can be respectively applied to the plurality of heaters HT. The on and off of respective electrical connection states of the plurality of heaters HT are independently controlled. Further, respective temperatures of the plurality of heaters HT are independently measured. In other words, the heaters HT of the display apparatus 1G include a plurality of blocks that can be independently operated. Each of the plurality of heater blocks is electrically connectable to the control circuit 500 and the heater driving circuit 300 which are provided on the substrate 92, via a connector. In the example illustrated in FIG. 12, the heater HT includes a heater block HTa and a heater block HTb. Thus, the power consumption can be reduced when the surface of the display apparatus IG has a temperature distribution.

The display apparatus 1A illustrated in FIG. 4 can further include an adhesive layer. The adhesive layer is provided, for example, between the lower surface of the array substrate 10 and the upper surface of the planarizing layer 60. The adhesive layer has an upper surface and a lower surface on the opposite side to the upper surface. The upper surface of the adhesive layer is in contact with the lower surface of the array substrate. The lower surface of the adhesive layer is in contact with the upper surface of the planarizing layer 60. The adhesive layer plays a role of adhering the array substrate 10 and the planarizing layer 60 to each other. By the adhesive layer, the planarizing layer 60 and the back cover substrate 51 are fixed to the array substrate 10. The adhesive layer has a visible-light transmission property. The refractive index of the adhesive layer is preferably closer to the respective refractive indexes of the planarizing layer 60 and the array substrate 10 than the refractive index of air. When the refractive index of the adhesive layer is equal to those of the planarizing layer 60 and the array substrate 10, reflection of the light L1 on an interface between the adhesive layer and the upper surface of the planarizing layer 60 and the lower surface of the array substrate 10. Examples of the adhesive layer are a sheet-shaped transparent adhesive sheet referred to as an OCA (optical clear adhesive) and OCR (optical clear resin) used by hardening a liquid transparent adhesive agent.

In the scope of the idea of the present invention, various modification examples and alteration examples could have been easily anticipated by those who are skilled in the art, and it would be understood that these various modification examples and alteration examples are within the scope of the present invention. For example, the ones obtained by appropriate addition, removal, or design-change of the components to/from/into each of the above-described embodiments by those who are skilled in the art or obtained by addition, omitting, or condition-change of the step to/from/into each of the above-described embodiments are also within the scope of the present invention as long as they include the idea of the present invention.

Also, as to other operations and effects resulted from the aspects described in the present embodiments, it would be understood that the present invention obviously results in the operations and effects that are clearly provided from the descriptions of the specification or that can be appropriately anticipated by those who are skilled in the art.

What is claimed is:

1. A display apparatus comprising:
a first substrate;
a second substrate facing the first substrate;
a liquid crystal layer provided between the first substrate and the second substrate;
a heater having a terminal and overlapping a region where the liquid crystal layer is provided in plan view;
a measurement circuit having a terminal electrically connectable to the terminal of the heater;
a heater driving circuit having a terminal electrically connectable to the terminal of the heater; and
a switch circuit,
wherein the switch circuit is capable of switching on and off of an electrical connection state between the terminal of the heater and the terminal of the measurement circuit and is capable of switching on and off of an electrical connection state between the terminal of the heater and the terminal of the heater driving circuit.

2. The display apparatus according to claim 1, further comprising
a control circuit,
wherein the control circuit performs control such that the electrical connection state between the terminal of the heater and the terminal of the heater driving circuit is turned off when the electrical connection state between the terminal of the heater and the terminal of the measurement circuit is on, and performs control such that the electrical connection state between the terminal of the heater and the terminal of the measurement circuit is turned off when the electrical connection state between the terminal of the heater and the terminal of the heater driving circuit is on.

3. The display apparatus according to claim 1, further comprising
a control circuit,
wherein the control circuit controls the heater driving circuit, based on a measurement result of the measurement circuit.

4. The display apparatus according to claim 1, further comprising:
a control circuit; and
a light source provided outside the region where the liquid crystal layer is provided in plan view,
wherein the control circuit performs control such that the electrical connection state between the terminal of the heater and the terminal of the measurement circuit is turned on and the electrical connection state between the terminal of the heater and the terminal of the heater driving circuit is turned off when the light source emits light.

5. The display apparatus according to claim 1, further comprising:
a control circuit; and
a light source provided outside the region where the liquid crystal layer is provided in plan view,
wherein the light source is controlled to have a first period during which light is emitted and a second period during which light is emitted in a time period different from the first period, and
the control circuit is configured to:
in the first period, perform control such that the electrical connection state between the terminal of the heater and the terminal of the measurement circuit is turned on while the electrical connection state between the terminal of the heater and the terminal of the heater driving circuit is turned off, and
in the second period, perform control such that the electrical connection state between the terminal of the heater and the terminal of the measurement circuit is turned off while the electrical connection state between the terminal of the heater and the terminal of the heater driving circuit is turned on.

6. The display apparatus according to claim 1,
wherein the switch circuit includes a relay.

7. The display apparatus according to claim 1,
wherein the switch circuit includes a MOS transistor.

8. The display apparatus according to claim 1,
wherein the measurement circuit is a temperature measurement circuit measuring a temperature of the heater.

9. The display apparatus according to claim 1,
wherein the heater includes a first heater block and a second heater block, and
the switch circuit is capable of independently switching on and off of respective electrical connection states of the first heater block and the second heater block.

10. The display apparatus according to claim 1,
wherein the heater includes a heater wiring overlapping the region where the liquid crystal layer is provided in plan view, and
the heater wiring contains a metal.
